(19) United States
(12) Patent Application Publication
(10) Pub. No.: US 2025/0374197 A1
(43) Pub. Date: Dec. 4, 2025

(54) ELECTRONIC DEVICE FOR VEHICLE, SEMICONDUCTOR CHIP AND OPERATING METHOD FOR THE SAME

(71) Applicant: SAMSUNG ELECTRONICS CO., LTD., Suwon-si (KR)

(72) Inventors: Boyoun PARK, Suwon-si (KR); Chungwoo Park, Suwon-si (KR); Heungyeol Kim, Suwon-si (KR); Insoo Park, Suwon-si (KR)

(73) Assignee: SAMSUNG ELECTRONICS CO., LTD., Suwon-si (KR)

(21) Appl. No.: 18/973,956

(22) Filed: Dec. 9, 2024

(30) Foreign Application Priority Data
May 31, 2024 (KR) 10-2024-0071854

(51) Int. Cl. H04W 52/02; H04W 4/48

(52) U.S. Cl. CPC H04W 52/0264; H04W 4/48

(57) ABSTRACT

An electronic device for a vehicle may include an application processor and a communication processor configured to communicate with the application processor and perform public land mobile network (PLMN) searches. The application processor is configured to receive a power mode change request to switch a power mode of the electronic device from a first operating mode to a second operating mode, based on the power mode change request, determine a network state of the communication processor included in the electronic device, and transmit, to the communication processor, a deactivation request to deactivate the PLMN searches based on the network state of the communication processor. The communication processor is configured to deactivate the PLMN searches in response to receiving the deactivation request from the application processor.

### CROSS-REFERENCE TO RELATED APPLICATION

This application claims priority to Korean Patent Application No. 10-2024-0071854, filed in the Korean Intellectual Property Office on May 31, 2024, the entire contents of which are hereby incorporated by reference.

### BACKGROUND

### 1. Field

The present disclosure relates to an electronic device for a vehicle, a semiconductor chip, and an operating method thereof.

### 2. Description of Related Art

A cellular modem including a communication processor (CP) may periodically perform public land mobile network (PLMN) searches to receive communication services. While the terminal is in motion, the cellular modem may continuously scan the surroundings for signals to acquire the optimal network for its current location. When the cellular modem detects a network that meets certain conditions, the cellular modem may perform a handover to that network.

Meanwhile, in the case of a vehicle, when the vehicle is parked, that is, when the engine is turned off by the driver, the vehicle may remain stationary. As a result, performing the PLMN searches might not yield a better signal than the currently registered network. In other words, if the vehicle is parked, the currently registered network may be the optimal network. However, because the PLMN searches algorithms of the cellular modem are typically designed based on the assumption that the terminal is in motion, the cellular modem mounted in the vehicle may keep performing the PLMN searches to acquire the optimal network even when the vehicle is parked. This operation of the cellular modem may lead to problems such as excessive increase in battery consumption of the vehicle and potential battery drain of the vehicle.

### SUMMARY

In order to solve one or more problems (e.g., the problems described above and/or other problems not explicitly described herein), the present disclosure provides an electronic device for a vehicle, a semiconductor chip, and an operating method thereof.

According to an aspect of the disclosure, an electronic device for a vehicle may include: a memory configured to store one or more instructions; an application processor configured to execute the one or more instructions stored in the memory; and a communication processor configured to communicate with the application processor and perform public land mobile network (PLMN) searches, wherein the application processor is configured to: receive a power mode change request to switch a power mode of the electronic device from a first operating mode to a second operating mode, based on the power mode change request, determine a network state of the communication processor included in the electronic device; and transmit, to the communication processor, a deactivation request to deactivate the PLMN searches based on the network state of the communication processor, and the communication processor is configured to deactivate the PLMN searches in response to receiving the deactivation request from the application processor.

According to another aspect of the disclosure, a semiconductor chip may include: an application processor configured to receive a power mode change request to switch a power mode of the semiconductor chip from a first operating mode to a second operating mode; and a communication processor configured to communicate with the application processor and perform public land mobile network (PLMN) searches, wherein the application processor is further configured to: in response to receiving the power mode change request to switch the power mode from the first operating mode to the second operating mode, determine a network state of the communication processor, transmit, to the communication processor, a deactivation request to deactivate the PLMN searches based on the network state of the communication processor, and the communication processor is configured to deactivate the PLMN searches in response to receiving the deactivation request from the application processor.

According to another aspect of the disclosure, an operating method executed by an application processor of an electronic device, may include: receiving a power mode change request to switch a power mode of the electronic device from a first operating mode to a second operating mode; in response to receiving the power mode change request, determining a network state of a communication processor included in the electronic device; and transmitting, to the communication processor, a deactivation request to deactivate public land mobile network (PLMN) searches based on the network state of the communication processor, to cause the communication processor to deactivate the PLMN searches.

According to some aspects, the PLMN searches of the communication processor are deactivated in the low power mode when the vehicle is stationary, leading to reduced power consumption of the electronic device of a vehicle. As a result, the battery consumption of the vehicle may be reduced, thereby preventing battery drain of the vehicle.

According to aspects of the present disclosure, the PLMN searches of the communication processor may be deactivated incrementally based on requests from the application processor, without requiring the communication processor to determine its network state.

According to some aspects, if the network connected to the communication processor is a no-service state, the communication processor may remain in the sleep mode, which is a low power mode, further saving power consumption of the electronic device of the vehicle. As a result, the battery consumption of the vehicle can be reduced, thereby preventing battery drain of the vehicle.

### BRIEF DESCRIPTION OF DRAWINGS

The above and other aspects will be more apparent by describing certain example embodiments, with reference to the accompanying drawings, in which:

FIG. 1 is a view provided to explain a method of an electronic device for vehicle for searching for a network and establishing a communication connection with a server according to one or more exemplary embodiments;

FIG. 2 is a view provided to explain an operating mode of a vehicle according to one or more exemplary embodiments;

FIG. 3 is a block diagram illustrating an example configuration of an electronic device for vehicle according to one or more exemplary embodiments;

FIG. 4 is a view illustrating an example of a time-power consumption graph of an application processor according to one or more exemplary embodiments;

FIG. 5 is a flowchart illustrating an example of an operating method of an application processor according to one or more exemplary embodiments;

FIG. 6 is a flowchart illustrating, in more detail, some processes in the example of the operating method illustrated in FIG. 5 according to one or more exemplary embodiments;

FIG. 7 is a block diagram provided to explain an internal configuration of an application processor according to one or more exemplary embodiments;

FIGS. 8A and 8B are views illustrating examples of the time-power consumption graph of a communication processor according to one or more exemplary embodiments;

FIG. 9 is a flowchart illustrating an example of an operating method of a communication processor according to one or more exemplary embodiments;

FIG. 10 is a flowchart illustrating an example of an operating method of an electronic device for vehicle according to one or more exemplary embodiments;

FIG. 11 is a flowchart illustrating an example of an operating method of an electronic device for vehicle according to one or more exemplary embodiments;

FIG. 12 is a view illustrating an example of an electronic device for vehicle in communication with a server according to one or more exemplary embodiments; and

FIG. 13 is a block diagram illustrating a configuration of a server according to one or more exemplary embodiments.

### DETAILED DESCRIPTION

Example embodiments are described in greater detail below with reference to the accompanying drawings.

In the following description, like drawing reference numerals are used for like elements, even in different drawings. The matters defined in the description, such as detailed construction and elements, are provided to assist in a comprehensive understanding of the example embodiments. However, it is apparent that the example embodiments can be practiced without those specifically defined matters. Also, well-known functions or constructions are not described in detail since they would obscure the description with unnecessary detail.

Expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, all of a, b, and c, or any variations of the aforementioned examples.

While such terms as “first,” “second,” etc., may be used to describe various elements, such elements must not be limited to the above terms. The above terms may be used only to distinguish one element from another.

In the present disclosure, the articles “a” and “an” are intended to include one or more items, and may be used interchangeably with “one or more.” Where only one item is intended, the term “one” or similar language is used. For example, the term “a processor” may refer to either a single processor or multiple processors. When a processor is described as carrying out an operation and the processor is referred to perform an additional operation, the multiple operations may be executed by either a single processor or any one or a combination of multiple processors.

In the present disclosure, a public land mobile network (PLMN) may refer to a network deployed and operated by a telecommunication service provider. The PLMN may have a unique identification code, and the identification code of the PLMN may include a mobile country code (MCC) and a mobile network code (MNC). In some aspects of the present disclosure, a “network” may refer to the PLMN, or a network including the PLMN.

In the present disclosure, a “home PLMN” may include a PLMN having MCC and MNC matching the international mobile subscriber identity (IMSI) of a mobile communication terminal (e.g., the vehicle-mounted electronic device). For example, the home PLMN may include a PLMN provided by a communication service provider that has a subscription relationship with the mobile communication terminal (or a user of the mobile communication terminal, or a provider of the mobile communication device) in the reference country of the mobile communication terminal.

In the present disclosure, a “roaming PLMN” may include a PLMN having an MCC that does not match the IMSI of the mobile communication terminal (e.g., the vehicle-mounted electronic device). For example, the roaming PLMN may include a PLMN that has entered into a roaming agreement with a communication service provider having a subscription relationship with the mobile communication terminal in a country other than the reference country of the mobile communication terminal.

In some aspects of the present disclosure, the description that the mobile communication terminal (e.g., the vehicle-mounted electronic device) is in a “registered state” or “connected state” with a specific network may include not only a state in which the mobile communication terminal is connected to the specific network and is performing data communication, but also a state in which the mobile communication terminal is not performing data communication with the specific network but is in a standby mode while maintaining a connection to be able to use the communication service of the specific network, that is, a camp on state.

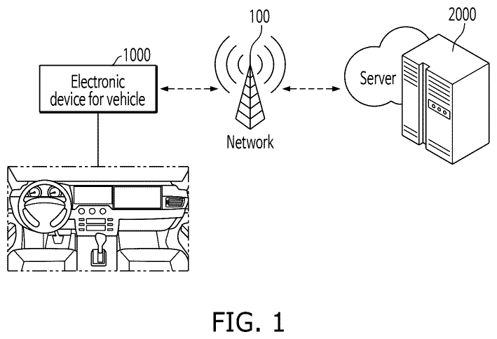

FIG. 1 is a view provided to explain a method of an electronic device 1000 for a vehicle to search for a network 100 and establishing a communication connection with a server 2000. The electronic device 1000 may be a telematics control unit (TCU) in a vehicle that enables communication between the vehicle and an outside network in response to requests from an electronic control unit (ECU), or may be incorporated in to the ECU. Referring to FIG. 1, the electronic device 1000 may search for the network 100 to perform data communication with the server 2000. The electronic device 1000 may be a telematics control device, a telecommunication control device, etc. mounted in the vehicle, but is not limited thereto. The electronic device 1000 may maintain a communication connection with the network 100 to remotely provide and manage connected services not only while the vehicle is operating, but also while the vehicle's engine is turned off (that is, while the vehicle's engine is not running).

The electronic device 1000 may perform operations related to the data communication with the server 2000 outside the vehicle. For example, the electronic device 1000 (e.g., a communication processor included in the electronic device 1000) may perform a search for establishing a communication connection with the network 100.

The electronic device 1000 may perform PLMN searches to receive communication services. For example, the electronic device 1000 in a first operating mode (e.g., normal mode) may perform PLMN searches at predetermined intervals.

The PLMN searches may include various types of PLMN searches. For example, the PLMN searches may include neighbor cell search, inter-radio access technology (RAT) search, home PLMN search, etc. Examples of Radio Access Technologies (RATs) include Global System for Mobile Communications (GSM), Universal Mobile Telecommunications System (UMTS), Long Term Evolution (LTE), and fifth-generation (5G) technology. The neighbor cell search may be a search for acquiring a network of better quality (e.g., higher signal strength, higher signal-to-noise ratio (SNR), etc.) among neighbor cells around the currently registered network cell. The inter-RAT search may be a search for acquiring a network that uses a wireless access technology superior to the wireless access technology of the currently registered network. For example, if the currently registered network is a third-generation (3G) network, the electronic device 1000 may perform the inter-RAT search to acquire a fourth-generation (4G) network, a fifth-generation (5G) network, etc. The home PLMN search may be a search for acquiring a home PLMN.

The electronic device 1000 may perform the PLMN searches based on a network state of the electronic device 1000.

For example, if the electronic device 1000 is registered with a specific PLMN, the electronic device 1000 may perform PLMN searches to receive communication services with better quality, speed, service content, etc. In a specific example, if the electronic device 1000 is registered with the home PLMN, the electronic device 1000 may perform the neighbor cell search and the inter-RAT search. In another specific example, if the electronic device 1000 is registered with a roaming PLMN, the electronic device 1000 may perform the neighbor cell search, the inter-RAT search, and the home PLMN search.

In yet another example, the electronic device 1000 may be in a no-service state. For example, the electronic device 1000 may not be located inside a coverage area of any PLMN and thus may be in the no-service state in which no communication services are available. In addition to being in a no-service state, the electronic device 1000 may also enter a limited-service state. For instance, when the device is outside its home network's coverage area but within the range of a different Public Land Mobile Network (PLMN) that does not have a roaming agreement with the user's communication service provider, only essential services may be accessible. In the limited-service state, the electronic device 1000 may only able to receive emergency services or make emergency calls, while other communication services remain unavailable. This limited-service state may be considered the same as or similar to the no-service state. If the state of the network 100 is the no-service state, the electronic device 1000 may perform the PLMN searches to restore the service state to the normal service state.

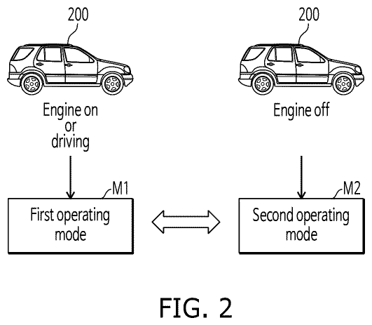

FIG. 2 is a view provided to explain an operating mode of a vehicle 200. Referring to FIG. 2, the electronic device mounted in the vehicle 200 may operate in various operating modes M1 and M2. If the engine of the vehicle 200 is running (e.g., if the ignition is turned on) or if the vehicle 200 is in motion, the power mode of the electronic device mounted in the vehicle 200 may be set to a first operating mode M1 (e.g., normal mode).

The electronic device for the vehicle 200 may receive power from an in-vehicle battery in the first operating mode M1. Since the engine of the vehicle 200 is running in the first operating mode M1, a battery in the vehicle 200 may be charged with the electric energy converted from the kinetic energy generated by the running engine.

Both the application processor and the communication processor included in the electronic device may operate in the first operating mode M1. For example, in the first operating mode M1, the communication processor included in the electronic device may perform the PLMN searches at predetermined intervals, and the application processor may control other configurations (e.g., communication processor, etc.) included in the electronic device.

If it is determined that the engine of the vehicle 200 stops running (e.g., if the ignition is turned off), or the engine of the vehicle 200 has stopped running and that the user (e.g., driver) of the vehicle 200 is outside the vehicle 200, the power mode of the electronic device may switch from the first operating mode M1 to a second operating mode M2 (e.g., a low power mode or a standby mode). For example, whether the user is outside the vehicle 200 may be determined based on door opening or closing signals from the vehicle 200, signals from a smart key associated with the vehicle 200, etc., but is not limited thereto. Meanwhile, the operating mode is not necessarily switched from the first operating mode M1 to the second operating mode M2. For example, the operating mode may be switched from other operating modes (e.g., a third operating mode, etc.) to the second operating mode M2. In another example, the second operating mode M2 may be a default mode, and the electronic device may be operated in the second operating mode M2 from the start.

In the second operating mode M2, the electronic device may receive power from the battery in the vehicle 200. Since the engine of the vehicle 200 is not running in the second operating mode M2, the battery in the vehicle 200 may not be charged and the operation of the electronic device may consume the electric energy of the charged battery in the vehicle 200.

Unlike in the first operating mode M1, the vehicle 200 in the second operating mode M2 may be stationary. Therefore, performing the PLMN searches in the second operating mode M2 may not identify a PLMN with a higher priority than the currently registered network. In other words, the network connected to the electronic device for the vehicle 200 at the time of switch to the second operating mode M2 may be the optimal network at that location. Alternatively, if the vehicle 200 does not have a registered network in the second operating mode M2, i.e., if the vehicle 200 is in the no-service state, performing PLMN searches may not yield any available networks, regardless of the attempts made.

In response to receiving a request to switch from the first operating mode M1 to the second operating mode M2, the electronic device for the vehicle 200 may deactivate the search for establishing a communication connection with the network. For example, in response to receiving the request to switch from the first operating mode M1 to the second operating mode M2, the electronic device may identify the network state of the electronic device to deactivate the PLMN searches. The electronic device may deactivate the PLMN searches in steps based on the identified network state.

If it is determined that the engine of the vehicle 200 is started (e.g., if the ignition is turned on) or that the vehicle 200 is operating, the operating mode may be switched from the second operating mode M2 to the first operating mode M1. For example, when the vehicle 200 is operating, it may include not only a normal operation that follows the user starting the vehicle, but also an abnormal operation such as towing or theft (e.g., If it is determined that the vehicle 200 is moved while the engine is turned off). Meanwhile, the operating mode is not necessarily switched from the second operating mode M2 to the first operating mode M1. For example, the operating mode may be switched from other operating modes (e.g., a third operating mode, etc.) to the second operating mode M1. In another example, the first operating mode M1 may be a default mode, and the electronic device may be operated in the first operating mode M1 from the start.

The electronic device may activate the deactivated PLMN searches in response to receiving a request to switch from the second operating mode M2 to the first operating mode M1.

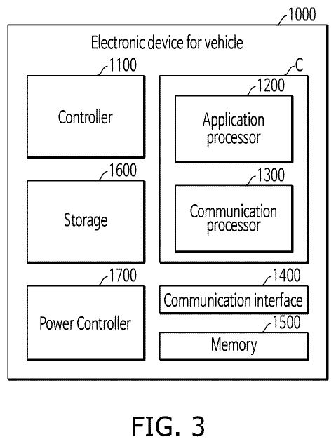

FIG. 3 is a block diagram illustrating an example of a configuration of the electronic device 1000. Referring to FIG. 3, the electronic device 1000 may include a controller 1100, an application processor 1200, a communication processor 1300, a communication interface 1400, a memory 1500, a storage 1600, and a power controller 1700. The application processor 1200 and the communication processor 1300 may be integrated into the TCU of the vehicle, and a power mode of the TCU may be set based on a power mode change request or vehicle state information received from the ECU.

The electronic device 1000 may include an electronic device for implementing in-vehicle infotainment (IVI) technology and/or advanced driver assistance system (ADAS). For example, the electronic device 1000 may provide services, information, and/or content to users. The electronic device 1000 may perform the communication between the vehicle and an external device to acquire information required for the operation or use of the vehicle. Alternatively, the electronic device 1000 may perform the communication between the vehicle and the external device to provide services, information, and/or content to users. The electronic device 1000 may be a telematics control unit mounted in the vehicle, but is not limited thereto.

The controller 1100 may control other components of the electronic device 1000. Alternatively, the controller 1100 may receive vehicle information, signals, data, and/or various requests from devices outside the electronic device 1000 mounted in the vehicle. For example, the controller 1100 may receive information about the state of the vehicle. The controller 1100 may transmit the received information, signals, data, and/or various requests to other components (e.g., application processor 1200, etc.) of the electronic device. For example, the controller 1100 may receive a request to switch operating mode (e.g., power mode) from another controller (e.g., main controller, etc.) mounted in the vehicle and transmit the request to switch operating mode to at least one of the processors 1200 and 1300. The controller 1100 may be implemented as an electronic control unit (ECU), a central processing unit, a microprocessor, etc., but is not limited thereto.

The application processor 1200 may control the overall operations of the electronic device 1000. For example, the application processor 1200 may execute one or more instructions stored in the memory 1500 to control various components of the electronic device 1000 and/or provide services, information, and/or content to users.

The application processor 1200 may include at least one of central process unit, microprocessor, graphic processing unit, application specific integrated circuits (ASICs), digital signal processors (DSPs), digital signal processing devices (DSPDs), programmable logic devices (PLDs), field programmable gate arrays (FPGAs), application processor (AP), neural processing unit, or artificial intelligence-specific processor designed with hardware architecture specialized in processing artificial intelligence models, but is not limited thereto.

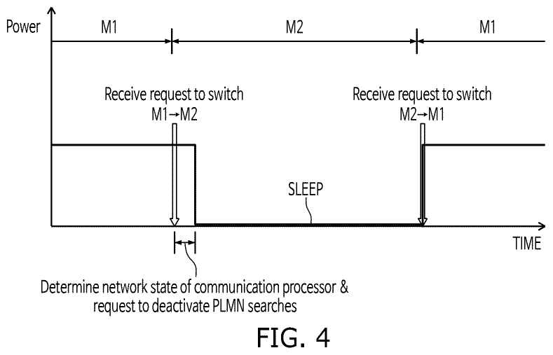

The application processor 1200 may control the PLMN searches of the communication processor 1300 based on the switching of the operating modes. For example, in response to receiving a request to switch from the first operating mode to the second operating mode, the application processor 1200 may transmit a request to deactivate PLMN searches to the communication processor 1300. In response to receiving a request to switch from the second operating mode to the first operating mode, the application processor 1200 may transmit a request to activate PLMN searches to the communication processor 1300. An aspect of the application processor 1200 controlling the PLMN searches of the communication processor 1300 will be described in detail below with reference to FIGS. 4 to 7.

The communication processor 1300 may be responsible for communication with an external electronic device (e.g. server, mobile terminal, etc.), and the communication processor 1300 may control the data transmission and reception of the electronic device 1000. The communication processor 1300 may perform the PLMN searches to use the communication services. For example, the communication processor 1300 may search and access PLMN by executing one or more instructions stored in the memory 1500.

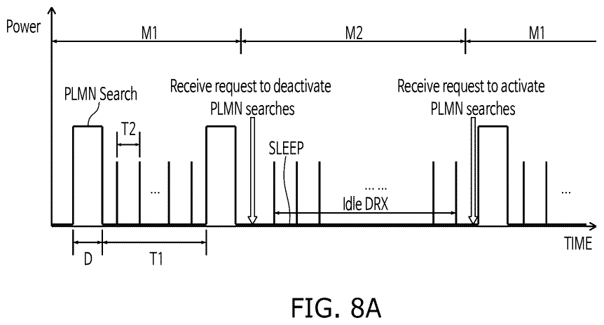

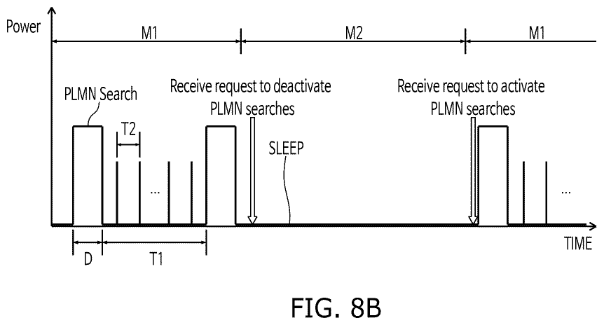

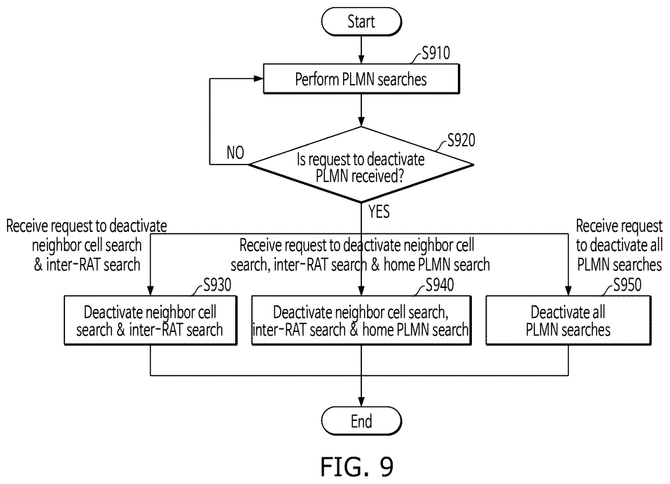

The communication processor 1300 may deactivate the PLMN searches in response to receiving the request to deactivate PLMN searches from the application processor 1200. Additionally, the communication processor 1300 may activate the PLMN searches in response to receiving the request to activate PLMN searches from the application processor 1200. An aspect of the communication processor 1300 deactivating or activating the PLMN searches in response to receiving a request from the application processor 1200 will be described in detail with reference to FIGS. 8A, 8B, and 9.

For example, the communication processor 1300 may include at least one of central processing unit, microprocessor, application specific integrated circuits (ASICs), digital signal processors (DSPs), digital signal processing devices (DSPDs), programmable logic devices (PLDs), field programmable gate arrays (FPGAs), and communication processor (CP) module, but is not limited thereto. The CP module may be a modem chipset and the network may communicate with the external electronic device over a communication network that complies with 3G, 4G, 5G, or 6G communication standards.

The application processor 1200 and the communication processor 1300 may be implemented as a single semiconductor chip C. For example, the application processor 1200 and the communication processor 1300 may be implemented as a single System on Chip (SoC). In this case, the application processor 1200 and the communication processor 1300 may communicate more quickly and securely using a communication mechanism within a single system. For example, if the application processor 1200 and the communication processor 1300 are implemented as a single semiconductor chip C, the application processor 1200 and the communication processor 1300 may communicate using an internal mailbox, but aspects are not limited thereto.

Alternatively, the application processor 1200 and the communication processor 1300 may also be implemented by being included in separate semiconductor chips. In this case, the application processor 1200 and the communication processor 1300 may communicate using a communication mechanism among peripheral devices. For example, if the application processor 1200 and the communication processor 1300 are implemented by being included in separate semiconductor chips, the application processor 1200 and the communication processor 1300 may communicate using peripheral component interconnect (PCI) and/or PCI Express (PCIE), but aspects are not limited thereto.

The communication interface 1400 may perform data communication with a server or a base station using at least one of data communication methods including wireless LAN, Wi-Fi, Bluetooth, Zigbee, Wi-Fi Direct (WFD), infrared data association (IrDA), Bluetooth Low Energy (BLE), wireless broadband internet (Wibro), world interoperability for microwave access (WiMAX), shared wireless access protocol (SWAP), Wireless Gigabit Alliance (WiGig), and RF communication.

The communication interface 1400 may include at least one communication module that performs wireless communication. For example, the communication interface 1400 may include at least one of antenna, Bluetooth module, Wi-Fi module, GPS module, and RF module.

In addition, the communication interface 1400 may include at least one communication module that performs communications in accordance with communication standards such as Bluetooth Low Energy (BLE), Near Field Communication (NFC), Radio frequency Identification (RFID), Wi-Fi Direct, Ultra-Wideband (UWB), and/or Zigbee.

The memory 1500 and the storage 1600 may store instructions, data structures, and program code, which are readable by the processors 1200 and 1300. Additionally or alternatively, the memory 1500 and the storage 1600 may store data and/or information generated by the processors 1200 and 1300, data and/or information provided to the processors 1200 and 1300, and data and/or information acquired by the processors 1200 and 1300, etc.

The storage 1600 may store data and/or programs for an algorithm for an operation of the application processor 1200 and/or the communication processor 1300, and when the application processor 1200 and/or the communication processor 1300 perform the operation, the data and/or programs may be loaded into the memory 1500. The operations performed by the application processor 1200 and the communication processor 1300 may be implemented by executing the instructions or codes of the programs stored in the memory 1500.

The memory 1500 and/or the storage 1600 may include a non-volatile memory including at least one of the flash memory type, hard disk type, multimedia card micro type, card type memory (e.g., SD or XD memory), read-only memory (ROM), electrically erasable programmable read-only memory (EEPROM), programmable read-only memory (PROM), magnetic memory, magnetic disk, or optical disk, and a volatile memory such as random access memory (RAM), dynamic random access memory (DRAM), or static random access memory (SRAM).

In one or more embodiment, the memory 1500 may be used to temporarily hold data and instructions that the processors 1200 and 1300 actively use during operations, to allow for quick access and manipulation of data while programs are running. The storage 1600 may be used for long-term retention of data and programs, keeping information even when the power is off. The storage 1600 may contain data and algorithms for the application processor 1200 and/or the communication processor 1300. When needed, this data and these programs are loaded into memory 1500 for processing by the processors 1200 and 1300. The storage 1600 may include non-volatile memory types, such as flash memory, hard drives, or optical disks, while the memory 1500 may include volatile memory types like random access memory (RAM). However, these embodiments are not limited to this description. The memory 1500 and storage 1600 may be utilized for both temporary data and for permanent data and programs that can be retrieved later. Additionally, the terms “memory” and “storage” may be used interchangeably in certain contexts.

The power controller 1700 may provide power to at least one component included in the electronic device 1000. In addition, the power controller 1700 may generally control the power supply to the electronic device 1000. The power controller 1700 may be a power management integrated circuit (PMIC), but is not limited thereto.

Meanwhile, the block diagram of the electronic device 1000 illustrated in FIG. 3 is an example of a configuration of the electronic device 1000, and the components in the block diagram may be integrated, added, or omitted according to the specifications of each device actually implemented. In other words, two or more components may be combined into a single component, or one component may be divided into two or more components, as needed. In addition, the functions performed in each block are intended to describe the aspects, and specific operations or devices do not limit the scope of the present disclosure. For example, the controller 1100, the application processor 1200, the communication processor 1300, and the power controller 1700 may be implemented using one or more processors.

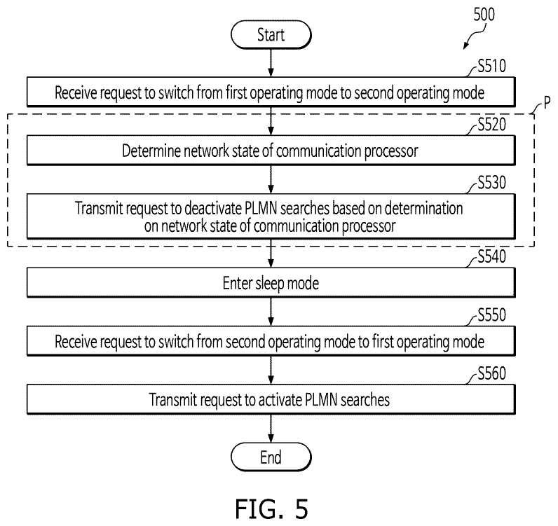

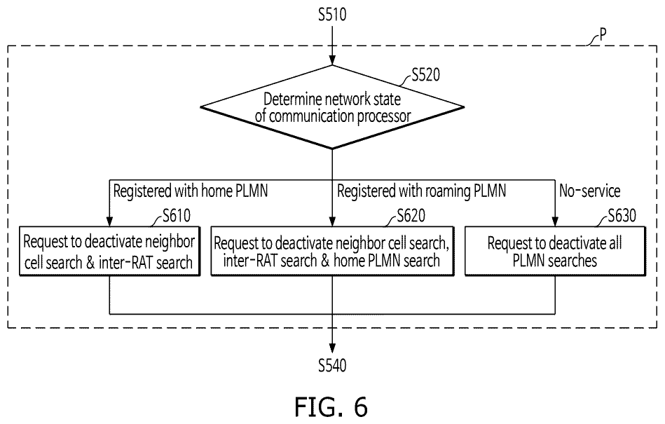

FIG. 4 is a view illustrating an example of a time-power consumption graph of the application processor, FIG. 5 is a flowchart illustrating an example of an operating method 500 of the application processor, and FIG. 6 is a flowchart illustrating, in more detail, some processes in the example of the operating method illustrated in FIG. 5. Referring to FIGS. 4 and 5, the operating method 500 of the application processor may begin in the first operating mode M1 (e.g., a normal mode, which is also referred to as active mode). In the first operating mode M1, most of the blocks of the application processor may be in the active (awake) state.

The application processor may receive a request to switch from the first operating mode M1 to the second operating mode M2 (e.g., to a low power mode), in operation S510. For example, the application processor may receive a request to switch from the first operating mode M1 to the second operating mode M2 from the controller included in the electronic device.

In response to receiving a request to switch from the first operating mode M1 to the second operating mode M2, the application processor may determine the network state of the communication processor, in operation S520. In addition, the application processor may transmit a request to deactivate PLMN searches to the communication processor based on the determination on the network state of the communication processor, in operation S530.

The application processor may generate a request to deactivate steps of PLMN searches based on the network state of the communication processor and transmit the generated request to deactivate steps of PLMN searches to the communication processor. For example, referring to FIG. 6, in response to receiving the request to switch from the first operating mode M1 to the second operating mode M2, the application processor may determine the network state of the communication processor, in operation S520.

If it is determined that the communication processor is registered with the home PLMN, the application processor may transmit a request to deactivate neighbor cell search and inter-RAT search to the communication processor, in operation S610. On the other hand, if it is determined that the communication processor is registered with the roaming PLMN, the application processor may transmit a request to deactivate neighbor cell search, inter-RAT search, and home PLMN search to the communication processor, in operation S620. Conversely, if it is determined that the communication processor is in the no-service state, the application processor may transmit a request to deactivate all PLMN searches to the communication processor, in operation S630. The PLMN searches of the communication processor may be deactivated based on the request to deactivate PLMN searches.

Referring to FIGS. 4 and 5 again, after transmitting the request to deactivate PLMN searches to the communication processor, the application processor may enter a sleep mode, in operation S540. Most components except for an active component may remain deactivated in the sleep mode. For example, in the sleep mode, all components except for the active component and memory may be deactivated and the data of memory may be kept in a minimum power state. The active component may remain active or awake in both of the operating modes M1 and M2 to detect interrupts. Since the application processor remains in the sleep mode, the application processor may consume only a small amount of power. The sleep mode may be maintained until the application processor receives (or detects) a request to switch its operating mode.

The application processor may receive a request to switch from the second operating mode M2 to the first operating mode M1, in operation S550. For example, while the sleep mode is maintained, the active component of the application processor may receive or detect an interrupt to switch from the second operating mode M2 to the first operating mode M1. The request to switch from the second operating mode M2 to the first operating mode M1 may be received from the controller or the communication processor of the electronic device, but aspects are not limited thereto.

In response to receiving a request to switch from the second operating mode M2 to the first operating mode M1, the application processor may terminate the sleep mode and transmit a request to activate PLMN searches to the communication processor, in operation S560. In response to the sleep mode being terminated, most of the components of the application processor may switch to the active (awake) state.

FIG. 4 illustrates that the power consumption of the application processor remains constant while the same operating mode (e.g., a sleep mode or an active mode) is maintained within a predetermined margin, but this is only a simplified representation of the difference in power consumption between the intervals, and aspects are not limited thereto. In actual implementations, the power consumption of the application processor may vary in the interval in which the sleep mode is maintained or in the interval in which mode other than the sleep mode is maintained.

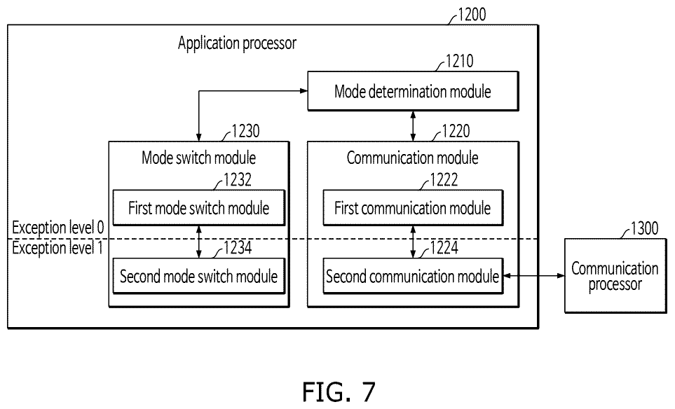

FIG. 7 is a block diagram provided to explain an internal configuration of the application processor 1200. In FIG. 7, a module may refer to a unit that processes at least one function or operation, and each module may be implemented in hardware or software, or a combination of hardware and software.

Referring to FIG. 7, the application processor 1200 may include a mode determination module 1210, a communication module 1220, and a mode switch module 1230.

The mode determination module 1210 may determine the operating mode of the electronic device. For example, the mode determination module 1210 may receive the state of the vehicle from the controller of the electronic device. The mode determination module 1210 may determine the operating mode based on the received state of the vehicle. In addition, the mode determination module 1210 may transmit a request to switch operating mode to the communication module 1220 and the mode switch module 1230. For example, the mode determination module 1210 may transmit the request to switch from the first operating mode to the second operating mode to the communication module 1220 and the mode switch module 1230.

The communication module 1220 may receive a request to switch an operating mode from the mode determination module 1210 and communicate with the communication processor 1300 based on the received request. For example, based on the request to switch from the first operating mode to the second operating mode received from the mode determination module 1210, the communication module 1220 may determine the network state of the communication processor 1300. The communication module 1220 may transmit the request to deactivate PLMN searches to the communication processor 1300 based on the determined network state of the communication processor 1300.

Specifically, the communication module 1220 may include a first communication module 1222 located in a first kernel with exception level 0, and a second communication module 1224 located in a second kernel with exception level 1. The first communication module 1222 may receive a request to switch from the first operating mode to the second operating mode from the mode determination module 1210 and transmit the received request to the second communication module 1224. In response to receiving the request to switch from the first operating mode to the second operating mode from the first communication module 1222, the second communication module 1224 may determine the network state of the communication processor 1300 and transmit a request to deactivate PLMN searches to the communication processor 1300 based on the determined network state of the communication processor 1300.

If the application processor 1200 and the communication processor 1300 are implemented as a single chip, the communication module 1220 of the application processor 1200 and the communication processor 1300 may communicate more quickly using the communication mechanism (e.g., internal mailbox) within the single system.

The mode switch module 1230 may receive a request to switch an operating mode from the mode determination module 1210 and switch the operating mode of the application processor 1200 based on the received request to switch operating mode. For example, the mode switch module 1230 may switch the application processor 1200 to the sleep mode based on receiving the request to switch from the first operating mode to the second operating mode from the mode determination module 1210.

Specifically, the mode switch module 1230 may include a first mode switch module 1232 located in the first kernel with exception level 0 and a second mode switch module 1234 located in a second kernel with exception level 1. The first mode switch module 1232 may receive a request to switch from the first operating mode to the second operating mode from the mode determination module 1210 and transmit the received request to the second mode switch module 1234. In response to receiving the request to switch from the first operating mode to the second operating mode from the first mode switch module 1232, the second mode switch module 1234 may switch the application processor 1200 to the sleep mode.

The mode switch module 1230 may switch the application processor 1200 to the sleep mode after the communication module 1220 transmits a request to deactivate PLMN searches to the communication processor 1300. Additionally or alternatively, transmitting the request to deactivate PLMN searches by the communication module 1220 and switching to the sleep mode by the mode switch module 1230 may be performed independently and/or in parallel.

FIG. 7 illustrates that the communication module 1220 and the mode switch module 1230 are separately implemented as two modules, but aspects are not limited thereto. The communication module 1220 and the mode switch module 1230 may be implemented as a single module or as three or more modules to perform or support the configuration described above.

FIGS. 8A and 8B are views illustrating examples of the time-power consumption graph of the communication processor, and FIG. 9 is a flowchart illustrating an example of an operating method 900 of the communication processor. Referring to FIGS. 8A, 8B, and 9, the operating method 900 of the communication processor may begin in the first operating mode M1 (e.g., a normal mode or an active mode). The communication processor may perform the PLMN searches in the first operating mode M1, in operation S910. For example, the communication processor may repeatedly perform the PLMN searches at first predetermined intervals T1 in the first operating mode M1.

The communication processor may perform the PLMN searches based on the network state of the communication processor. Specifically, if the communication processor is registered with the home PLMN, the communication processor may perform neighbor cell search and inter-RAT search. If the communication processor is registered with the roaming PLMN, the communication processor may perform neighbor cell search, inter-RAT search, and home PLMN search. If the network state of the communication processor is the no-service state (or the limited-service state), the communication processor may perform all PLMN searches to restore the service state to the normal service state.

The PLMN search operation may include repeating scanning and detecting a PLMN accessible to the communication processor at the current location. Duration D of the PLMN search operation may vary depending on whether the target PLMN is acquired through the PLMN search operation. For example, if the target PLMN is acquired through PLMN searches, the PLMN search operation may be terminated. In another example, if the target PLMN is not acquired through PLMN searches, the PLMN search operation may continue during a predetermined threshold time interval.

Additionally or alternatively, the communication processor may periodically (e.g., at every second predetermined interval T2) perform an activation operation (e.g., an active state in a discontinuous reception (DRX) operation) to receive signals and/or data from an external device (e.g., a server, etc.) that is capable of communicating with the communication processor. For example, the communication processor may periodically activate a transceiver to receive signals and/or data from a server. The communication processor may remain in the sleep mode in an interval in which the communication processor performs neither the PLMN search operation nor the activation operation (DRX). In the DRX operation, the communication processor may manage its reception intervals to save power while remaining connected to a network. The DRX operation may include an active period to listen for incoming data or control signals, and a sleep period to turn off its receiver to conserve battery. At the end of the sleep period, the communication processor may wake up to check for any incoming communications, and if no data is available, may return to sleep mode.

The communication processor may receive a request to deactivate PLMN searches from the application processor, in operation S920. For example, in response to receiving a request to switch from the first operating mode M1 to the second operating mode M2 (e.g., low power mode), the application processor may transmit the request to deactivate PLMN searches to the communication processor, and the communication processor may receive the request. In addition, the communication processor may deactivate the PLMN searches in response to receiving the request to deactivate PLMN searches from the application processor.

The communication processor may receive a request to deactivate steps of PLMN searches from the application processor and in response, deactivate the PLMN searches in steps. For example, in response to receiving a request to deactivate neighbor cell search and inter-RAT search from the application processor, the communication processor may deactivate neighbor cell search and inter-RAT search, in operation S930. In another example, in response to receiving a request to deactivate neighbor cell search, inter-RAT search, and home PLMN search from the application processor, the communication processor may deactivate neighbor cell search, inter-RAT search, and home PLMN search, in operation S940. In still another example, in response to receiving a request to deactivate all PLMN searches from the application processor, the communication processor may deactivate all PLMN searches, in operation S950. As described above, the PLMN searches of the communication processor may be deactivated in steps based on the request to deactivate steps of the PLMN searches of the application processor, without requiring the communication processor to determine its network state. In the second operating mode M2, because the PLMN searches of the communication processor are deactivated, power consumption by the PLMN searches can be saved.

While the PLMN searches are deactivated, the communication processor may receive a request to activate PLMN searches from the application processor. For example, the application processor may receive a request to switch from the second operating mode M2 to the first operating mode M1 from the controller or the communication processor, and transmit the request to activate PLMN searches to the communication processor. In response to receiving the request to activate PLMN searches from the application processor, the communication processor may activate the PLMN searches. As a result, the communication processor may perform the PLMN searches again.

The communication processor may continuously perform the periodic activation operation (DRX) even in the second operating mode M2 in which the PLMN searches is deactivated. For example, as illustrated in FIG. 8A, even in the second operating mode M2 in which the PLMN searches is deactivated, the communication processor may perform the activation operation (DRX) at second predetermined intervals T2 to receive an interrupt for mode switching from an external device (e.g., a server). The mode of performing periodic activation operation (DRX) may be referred to as an Idle DRX mode.

If the network state of the communication processor is the no-service state, signals and/or data may not be received from the external device even if the communication processor periodically performs the activation operation (DRX). As a result, if the network state of the communication processor is the no-service state, the periodic activation operation (DRX) of the communication processor may stop in the second operating mode M2 and the communication processor may remain in the sleep mode, as illustrated in FIG. 8B.

For example, the application processor may receive a request to switch from the first operating mode M1 to the second operating mode M2 and determine the network state of the communication processor. If it is determined that the network state of the network communication processor is the no-service state, the application processor may transmit a request to terminate periodic activation operation (DRX) to the communication processor. In response to receiving the request to terminate periodic activation operation (DRX) from the application processor, the communication processor may terminate the periodic activation operation (DRX) and enter the sleep mode. In this case, the communication processor may remain in the sleep mode until the communication processor receives at least one of a request to activate PLMN searches or a request to resume periodic activation operation (DRX) from the application processor. According to this aspect, if the network state of the communication processor is the no-service state, the communication processor may remain in the sleep mode in the second operating mode M2, thus further saving the power consumption of the electronic device.

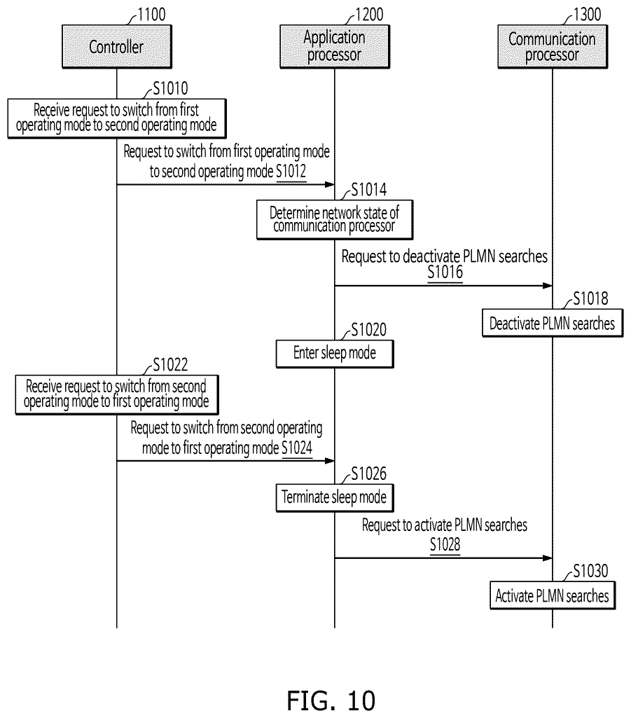

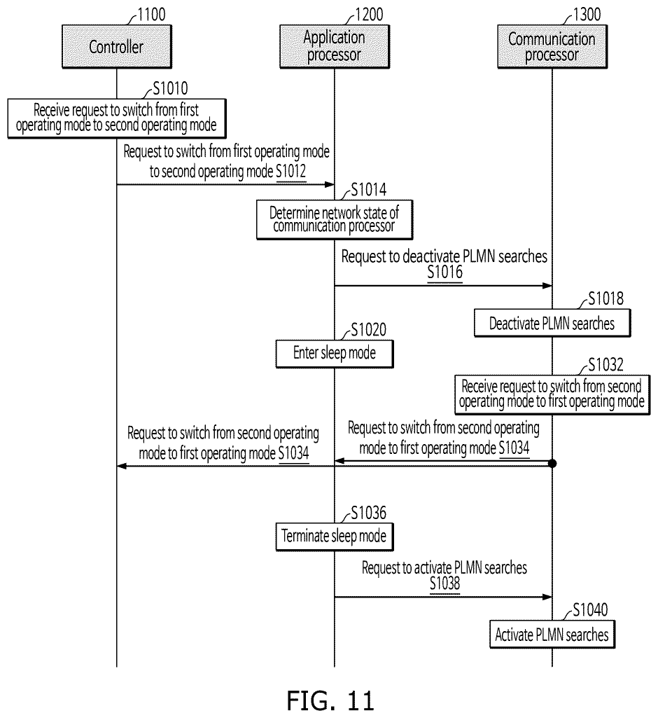

FIGS. 10 and 11 are flowcharts illustrating examples of the operating method of the electronic device. Referring to FIGS. 10 and 11, the operating method of the electronic device may begin in the first operating mode (e.g., in normal mode). The controller 1100 of the electronic device may receive a request to switch from the first operating mode to the second operating mode (e.g., low power mode) from an external configuration (e.g., another controller mounted in the vehicle), in operation S1010. The controller 1100 may generate a request to switch from the first operating mode to the second operating mode and transmit the generated request to the application processor 1200 of the electronic device, in operation S1012.

In response to receiving the request to switch from the first operating mode to the second operating mode (e.g., low power mode), the application processor 1200 may determine the network state of the communication processor 1300 of the electronic device, in operation S1014. In addition, the application processor 1200 may transmit a request to deactivate PLMN searches to the communication processor 1300 based on the determination on the network state of the communication processor 1300, in operation S1016. After transmitting the request to deactivate PLMN searches to the communication processor 1300, the application processor 1200 may enter the sleep mode, in operation S1020. In response to receiving the request to deactivate PLMN searches from the application processor 1200, the communication processor 1300 may deactivate the PLMN searches, in operation S1018.

The controller 1100 or the communication processor 1300 of the electronic device may receive a request to switch from the second operating mode to the first operating mode. For example, referring to FIG. 10, the controller 1100 of the electronic device may receive the request to switch from the second operating mode to the first operating mode from an external configuration (e.g., another controller mounted in the vehicle), in operation S1022. The controller 1100 may generate a request to switch from the second operating mode to the first operating mode and transmit the generated request to the application processor 1200, in operation S1024.

In response to receiving the request to switch from the second operating mode to the first operating mode from the controller 1100, the application processor 1200 may terminate the sleep mode in operation S1026, and transmit a request to activate PLMN searches to the communication processor 1300 in operation S1028. In response to receiving the request to deactivate PLMN searches from the application processor 1200, the communication processor 1300 may activate the PLMN searches, at S1030.

In another example, referring to FIG. 11, the communication processor 1300 of the electronic device may receive a request to switch from the second operating mode to the first operating mode from an external device (e.g., server) that is capable of communicating with the communication processor 1300, in operation S1032. For example, the server may receive, from the user terminal, a request (e.g., a request to start engine) to switch from the second operating mode to the first operating mode, and in response, transmit the request to switch from the second operating mode to the first operating mode to the communication processor 1300.

The communication processor 1300 may generate a request to switch from the second operating mode to the first operating mode and transmit the generated request to switch from the second operating mode to the first operating mode to at least some configurations of the vehicle, including the controller 1100 and the application processor 1200, in operation S1034. In response to receiving the request to switch from the second operating mode to the first operating mode from the communication processor 1300, the application processor 1200 may terminate the sleep mode in operation S1036, and transmit a request to activate PLMN searches to the communication processor 1300, in operation S1038. In response to receiving the request to deactivate PLMN searches from the application processor 1200, the communication processor 1300 may activate the PLMN searches, in operation S1040.

The operating method described above with reference to FIGS. 4 to 11 is only an example, and aspects are not limited thereto. At least one operation of the operating method described above with reference to FIGS. 4 to 11 may be added, changed, and/or deleted, a subject that performs at least one operation may be changed, or the order of operations may be changed.

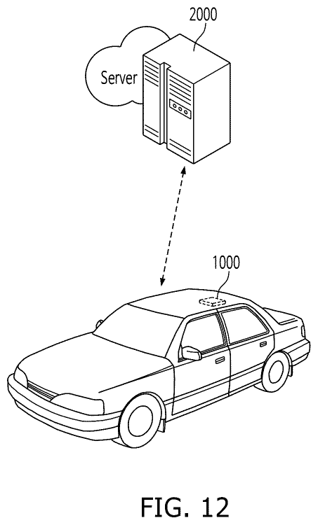

FIG. 12 is a view illustrating an example of the electronic device 1000 in communication with the server 2000. Referring to FIG. 12, the server 2000 may include a server, a server system, a server-based device, etc., which may transmit and receive data to and from the electronic device 1000 over the communication network and process the data. The communication network may be the PLMN according to the aspects described above.

The server 2000 may transmit data related to the roaming agreement, which may include a mobile country code and a mobile network code value of a specific communication service provider, a mobile country code for a country corresponding to the mobile country code of the specific communication service provider, and a mobile network code of another communication service provider corresponding to the mobile network code of the specific communication service provider, to the electronic device 1000 over the communication network 2100.

The electronic device 1000 may receive and store the data related to the roaming agreement from the server 2000 while the ignition of the vehicle is turned on (e.g., in the first operating mode).

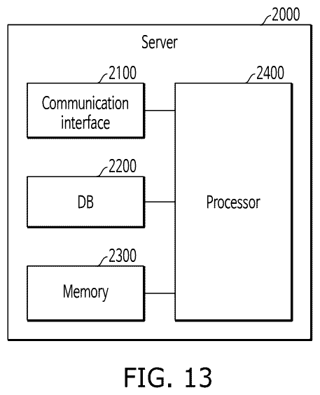

FIG. 13 is a block diagram illustrating a configuration of the server 2000. Referring to FIG. 13, the server 2000 may be interconnected to the electronic device by wireless communication method and may perform data communication. The server 2000 may include a communication interface 2100, a database (DB) 2200, a memory 2300, and a processor 2400.

The communication interface 2100 may include one or more components that enable communications over a local area network (LAN), a wide area network (WAN), a value-added network (VAN), a mobile radio communication network, a satellite communication network, and a combination thereof.

The communication interface 2100 may transmit the data related to the roaming agreement to the electronic device. In addition, in order to provide services, information, and/or content to users, the communication interface 2100 may transmit the services, information, and/or content to the electronic device.

The DB 2200 may store the data received from the electronic device and data to be provided by other external devices and by the server 2000 to the electronic device.

The memory 2300 may store various data, programs, or applications for driving and controlling the server 2000. The program stored in the memory 2300 may include one or more instructions. The program (one or more instructions) or application stored in the memory 2300 may be executed by the processor 2400.

The processor 2400 may control the overall operations of the server 2000. The processor 2400 may execute one or more programs stored in the memory 2300.

The processor 2400 may include an application processor (AP), a central processing unit (CPU), a graphic processing unit (GPU), a neural processing unit, or an artificial intelligence-specific processor designed with hardware architecture specialized in processing artificial intelligence models.

The processor 2400 may control the server 2000 to provide data, services, information, and content related to the roaming agreement to the electronic device 1000.

Note that the block diagram of the server 2000 illustrated in FIG. 13 is only an example of the server 2000, and aspects are not limited thereto. The components in the block diagram may be integrated, added, or omitted according to the specifications of each device actually implemented. In other words, two or more components may be combined into a single component, or one component may be divided into two or more components, as needed. In addition, the functions performed in each block are intended to describe the aspects, and specific operations or devices do not limit the scope of the present disclosure.

Certain examples of the present disclosure have been described above for purposes of illustration only, and those skilled in the art with ordinary knowledge of the present disclosure will be able to make various modifications, changes and additions within the spirit and scope of the present disclosure, and such modifications, changes and additions should be construed to be included in a scope of the claims.

The foregoing exemplary embodiments are merely exemplary and are not to be construed as limiting. The present teaching can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. An electronic device for a vehicle, the electronic device comprising:
a memory configured to store one or more instructions;
an application processor configured to execute the one or more instructions stored in the memory; and
a communication processor configured to communicate with the application processor and perform public land mobile network (PLMN) searches, wherein:
the application processor is configured to:
receive a power mode change request to switch a power mode of the electronic device from a first operating mode to a second operating mode;
based on the power mode change request, determine a network state of the communication processor included in the electronic device; and
transmit, to the communication processor, a deactivation request to deactivate the PLMN searches based on the network state of the communication processor, and
the communication processor is configured to deactivate the PLMN searches in response to receiving the deactivation request from the application processor.

2. The electronic device according to claim 1, wherein:
the application processor is further configured to transmit, to the communication processor, the deactivation request to deactivate neighbor cell search and inter-RAT search based on a determination that the communication processor is registered with a home PLMN, and
the communication processor is further configured to deactivate the neighbor cell search and the inter-RAT search in response to receiving the deactivation request to deactivate the neighbor cell search and the inter-RAT search from the application processor.

3. The electronic device according to claim 1, wherein:
the application processor is further configured to transmit, to the communication processor, the deactivation request to deactivate neighbor cell search, inter-RAT search, and home PLMN search based on a determination that the communication processor is registered with a roaming PLMN, and
the communication processor is further configured to deactivate the neighbor cell search, the inter-RAT search, and the home PLMN search in response to receiving the deactivation request to deactivate the neighbor cell search, the inter-RAT search, and the home PLMN search from the application processor.

4. The electronic device according to claim 1, wherein:
the application processor is further configured to transmit, to the communication processor, the deactivation request to deactivate all of the PLMN searches based on a determination that the communication processor is in a no-service state, and
the communication processor is further configured to deactivate all of the PLMN searches in response to receiving the deactivation request to deactivate all of the PLMN searches from the application processor.

5. The electronic device according to claim 1, wherein the second operating mode is activated based on determining that an engine of the vehicle comprising the electronic device is stopped, or determining that a user of the vehicle is outside the vehicle after the engine is stopped.

6. The electronic device according to claim 1, further comprising a controller configured to receive a state of the vehicle from an external device outside the electronic device,
wherein the application processor is configured to receive, from the controller, the power mode change request to switch from the first operating mode to the second operating mode.

7. The electronic device according to claim 1, wherein, after transmitting the deactivation request to the communication processor, the application processor is further configured to enter a sleep mode.

8. The electronic device according to claim 7, wherein:
after deactivating the PLMN searches, the communication processor is further configured to receive, from an external device, another power change request to switch from the second operating mode to the first operating mode, and transmit the other power change request to the application processor, and
in response to receiving the other power change request, the application processor is further configured to terminate the sleep mode and transmit, to the communication processor, an activation request to activate the PLMN searches.

9. The electronic device according to claim 1, wherein:
the application processor is further configured to transmit, to the communication processor, a termination request to terminate periodic activation operation based on determining that the communication processor is in a no-service state, and
the communication processor is further configured to:
terminate the periodic activation operation and enter a sleep mode, in response to receiving the termination request; and
remain in the sleep mode until the communication processor receives from the application process, at least one of an activation request to activate the PLMN searches or a resume request to resume the periodic activation operation.

10. The electronic device according to claim 7, wherein:
in response to receiving another power change request to switch from the second operating mode to the first operating mode, terminate the sleep mode and transmit, to the communication processor, an activation request to activate the PLMN searches, and
the communication processor is further configured to activate the PLMN searches in response to receiving the activation request from the application processor.

11. The electronic device according to claim 1, wherein the first operating mode is activated based on an engine of the vehicle being started, or based on the vehicle being in motion.

12. The electronic device according to claim 1, wherein the application processor and the communication processor are incorporated into a single semiconductor chip.

13. A semiconductor chip, comprising:
an application processor configured to receive a power mode change request to switch a power mode of the semiconductor chip from a first operating mode to a second operating mode; and
a communication processor configured to communicate with the application processor and perform public land mobile network (PLMN) searches, wherein
the application processor is further configured to:
in response to receiving the power mode change request to switch the power mode from the first operating mode to the second operating mode, determine a network state of the communication processor;
transmit, to the communication processor, a deactivation request to deactivate the PLMN searches based on the network state of the communication processor; and
the communication processor is configured to deactivate the PLMN searches in response to receiving the deactivation request from the application processor.

14. The semiconductor chip according to claim 13, wherein the application processor is further configured to:
generate the deactivation request to deactivate at least one step of the PLMN searches based on a registered network of the communication processor; and
transmitting, to the communication processor, the deactivation request to deactivate the at least one step of the PLMN searches.

15. An operating method executed by an application processor of an electronic device, the operating method comprising:
receiving a power mode change request to switch a power mode of the electronic device from a first operating mode to a second operating mode;
in response to receiving the power mode change request, determining a network state of a communication processor included in the electronic device; and
transmitting, to the communication processor, a deactivation request to deactivate public land mobile network (PLMN) searches based on the network state of the communication processor, to cause the communication processor to deactivate the PLMN searches.

16. The operating method according to claim 15, wherein the transmitting the deactivation request to the communication processor comprises:
transmitting the deactivation request to deactivate neighbor cell search and inter-RAT search based on a determination that the communication processor is registered with a home PLMN.

17. The operating method according to claim 15, wherein the transmitting the deactivation request to the communication processor comprises:
transmitting the network search deactivation request to deactivate neighbor cell search, inter-RAT search, and home PLMN search based on a determination that the communication processor is registered with a roaming PLMN.

18. The operating method according to claim 15, wherein the transmitting the deactivation request comprises:
transmitting the deactivation request to deactivate all of the PLMN searches based on a determination that the communication processor is in a no-service state.

19. The operating method according to claim 15, further comprising entering a sleep mode after transmitting the deactivation request.

20. The operating method according to claim 19, further comprising:
in response to receiving another power mode change to switch from the second operating mode to the first operating mode, terminating the sleep mode and transmitting, to the communication processor, an activation request to activate the PLMN searches.
